(19) United States
(12) Patent Application Publication
(10) Pub. No.: US 2012/0038270 A1
(43) Pub. Date: Feb. 16, 2012

(54) XENON FLASH LAMP

(75) Inventor: Michael R. HAMMER, Sassafras (AU)

(73) Assignee: Agilent Technologies Australia (M) Pty Ltd., Mulgrave (AU)

(21) Appl. No.: 13/184,625

(22) Filed: Jul. 18, 2011

(30) Foreign Application Priority Data
Aug. 16, 2010 (AU) 2010903680

(51) Int. Cl. H01J 61/12

(52) U.S. Cl. 313/570; 313/637

(57) ABSTRACT

A pulsable light source for a spectroscopy instrument is provided, the light source including a xenon flash lamp having an anode and a cathode within a sealed envelope of pressurized xenon gas, the anode and the cathode being spaced so that an arc can be struck between the anode and the cathode without the use of a trigger electrode.

### CROSS REFERENCES TO RELATED APPLICATIONS

This application claims the benefit of Australian Patent Application No. 2010903680 filed on Aug. 16, 2010, the subject matter of which is hereby incorporated by reference.

### TECHNICAL FIELD

The present invention relates to a pulsable light source including a xenon flash lamp, and a spectroscopy instrument that includes a pulsable light source.

### BACKGROUND

Xenon flash lamps are pulsable light sources that emit a broad spectral range. A xenon flash lamp includes an anode and a cathode contained within a sealed envelope of pressurized xenon gas. The lamp emits light from an electric arc discharge struck between the anode and cathode. The xenon gas lamp also includes one or more trigger electrodes positioned between the anode and the cathode. The purpose of such trigger electrodes is to guide the arc from the anode to each trigger electrode in turn and thus eventually to the cathode.

The number of trigger electrodes used depends on the spacing between the anode and cathode. A lamp having an arc length of 1.5 mm may have one or two trigger electrodes. The number of electrodes is increased to five or more for lamps having arc lengths of around 8 mm.

In recent times, xenon flash lamps have found favour for use in spectroscopy instruments because of their broad spectral range, the low power consumption and the pulsed operation. Pulsed operation is advantageous because it reduces the exposure of the sample to light and reduces the effect of ambient room light on the accuracy of the measurements

A problem with xenon flash lamps is that the position of the arc discharge tends to move from one flash to the next. In a spectroscopy instrument, an image of the arc discharge is projected onto an entrance slit. A consequence of the change in the position of the arc is that the image of the arc does not consistently fall uniformly over the entrance slit. This causes large variations in the intensity of light entering the instrument from one flash to the next. These variations in light intensity are manifested as noise in the output of the instrument. This represents a serious limitation on the performance achievable from a spectroscopy instrument using a xenon flash light source. Trigger electrodes are used to reduce the variation in the position of the arc from one flash to the next, however, variation is still observed.

Information provided by lamp manufacturers indicates that the most stable portion of the arc is its central region. Accordingly, an image of the central region of the arc should be projected onto the entrance slit of a spectroscopy instrument while projection onto said entrance slit of those regions of the arc adjacent to the electrodes, and particularly to the anode, should be avoided. Such selective imaging of the arc wastes light, since only a portion of the arc is imaged onto the entrance slit, but is believed to reduce noise. Even when all recommendations are followed, the noise performance of a spectroscopy instrument equipped with known xenon flash lamps is insufficient to meet many spectroscopic requirements.

An object of the present invention is to provide a pulsable xenon flash lamp in which the movement of the position of the arc from discharge to discharge is reduced.

### DISCLOSURE OF THE INVENTION

According to one aspect, the present invention provides a pulsable light source for a spectroscopy instrument, said light source including a xenon flash lamp having an anode and a cathode within a sealed envelope of pressurized xenon gas, the anode and the cathode being so spaced that an arc can be struck between the anode and the cathode without the use of a trigger electrode.

Contrary to prior art teachings, there is very little movement at the point of attachment of the arc to the anode or to the cathode. Consequently, the spatial stability of the arc is good in the region of the anode and cathode. This suggested the possibility of xenon flash lamp having a shorter arc length and no trigger electrodes.

The effect of the invention is to improve stability of the arc struck between the anode and cathode and thereby to increase the proportion of light from the arc falling over the entrance aperture of the spectroscopy instrument. This allows imaging of a larger fraction of the total arc length leading to greater light collection efficiency. The combination of reduced movement of the arc and increased light collection efficiency may produce a useful reduction of noise in the output of the spectroscopy instrument.

The distance between the anode and the cathode may be such that in use, an arc struck between them has an aspect ratio (arc length to arc diameter) that substantially matches the aspect ratio of the entrance aperture (aperture length to aperture width) of the spectroscopy instrument.

Modern spectroscopy instruments are required to work with smaller and smaller sample volumes, which dictate entrance apertures with low aspect ratios of around 3:1 or 4:1. The spacing of the anode and the cathode of the lamp of the pulsable light source of the present invention may be, for example, less than 1.5 mm, providing an arc aspect ratio of 6:1 or less. Having a smaller aspect ratio has the benefit that a larger fraction of the total light produced by the lamp may be used, yielding potentially greater light throughput.

The shorter arc length also reduces the amount of random arc wander over the discharge path, increasing the stability of the arc. This means that more of the arc may be imaged onto the entrance aperture.

Having a shorter arc length, however, may put too large a fraction of the supply voltage drop into the electrode/gas interface region and not enough into the arc itself, reducing the efficiency of conversion of electricity into light. This may be addressed by increasing the xenon gas pressure inside the sealed envelope, for example, to greater than 1 atmosphere.

In an embodiment, the spacing of the anode and the cathode is between 0.5 mm and 1 mm and the pressure of xenon gas within the sealed envelope is between 2 and 4 atmospheres.

The increased pressure of the xenon gas inside the sealed envelope enables the light source to be pulsed at a pulse repetition rate greater than 100 Hz.

In an embodiment, the pulse repetition rate of the light source may be in the range 300 Hz to 600 Hz, for example the pulse repetition rate may be 500 Hz.

According to another aspect, the present invention provides a spectroscopy instrument including:
an entrance aperture and
a pulsable light source including a xenon flash lamp including
   an anode and a cathode within a sealed envelope of pressurized xenon gas, the anode and the cathode being spaced less than 1.5 mm apart such that an arc can be struck between the anode and the cathode without the use of a trigger electrode,
wherein the spacing of the anode and the cathode is selected such that in use an arc between them has an aspect ratio (arc length to arc diameter) which substantially matches the aspect ratio of the entrance aperture of the spectroscopy instrument.

Of course, the xenon gas lamp used in the spectroscopy instrument could have any one of the features described above. For example, for an entrance aperture that has an aspect ratio below 4:1, the spacing of the anode and the cathode may be between 0.5 and 1 mm.

According to yet another aspect, the present invention provides a xenon flash lamp including an anode and a cathode within a sealed envelope of pressurized xenon gas, the anode and the cathode being spaced less than 1.5 mm apart such that an arc can be struck between the anode and the cathode without a trigger electrode.

For a better understanding of the invention and to show how it may be performed, embodiments thereof will now be described, by way of non-limiting example only, with reference to the accompanying drawings.

### BRIEF DESCRIPTION OF THE DRAWINGS

FIG. 1 is a highly schematic side view of a prior art xenon flash lamp showing a range of possible arc paths.

FIG. 2 is a highly schematic plan view of the prior art xenon flash lamp of FIG. 1 and an entrance aperture of a spectroscopy instrument.

FIG. 3 is a highly schematic plan view of a xenon flash lamp of a pulsable light source and an entrance aperture of a spectroscopy instrument according to an embodiment of the invention.

### DETAILED DESCRIPTION

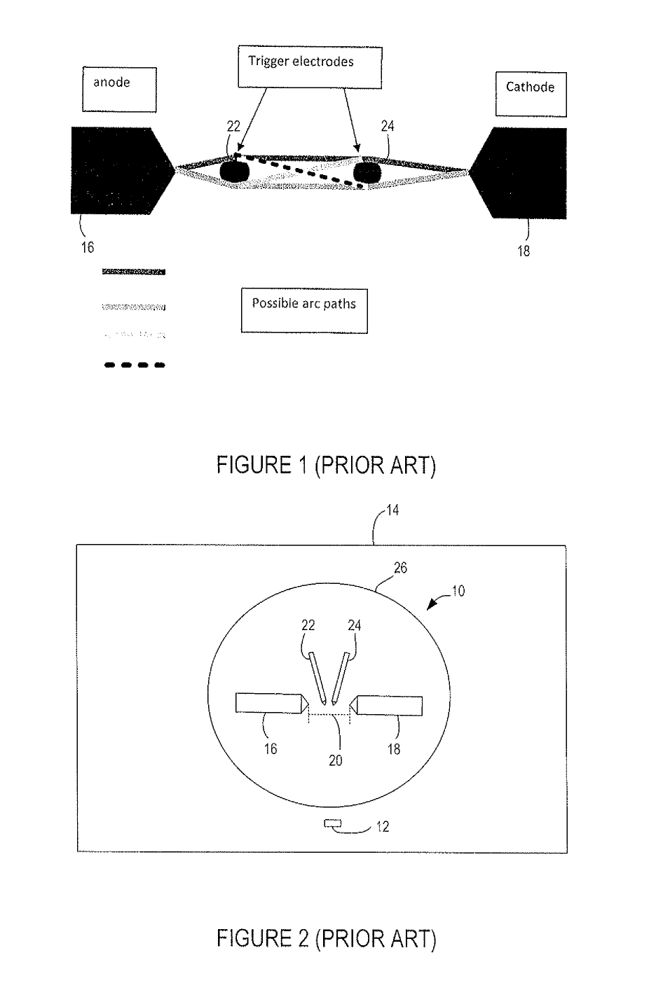

FIGS. 1 and 2 schematically illustrate a prior art xenon flash lamp 10. FIG. 2 also illustrates an entrance aperture 12 of a spectroscopy instrument 14. Spectroscopy instruments are known and so further details of the instrument have not been shown.

The xenon flash lamp 10 includes an anode 16 and a cathode 18 spaced apart by a distance 20 (shown in FIG. 2) and arranged so that their tips face each other. The distance 20 between the anode 16 and cathode 18 may be 1.5 mm, 3 mm or 8 mm. One or more trigger electrodes 22 and 24 are located between the anode 16 and cathode 18. The anode 16 and cathode 18 and trigger electrodes 22 and 24 are sealed within an envelope 26 of xenon gas pressurized to about 1 atmosphere.

In operation, the cathode 18 is connected to ground and an anode capacitor (not shown) is connected between the anode 16 and cathode 18. The anode capacitor is charged to a voltage, for example between about 200 and 1000 volts. This voltage is insufficient to cause the formation of an arc between the anode 16 and cathode 18. To initiate an arc, a very high voltage pulse, for example around 4000 volts or more, is applied between the trigger electrodes 22, 24 and the grounded cathode 18 via a trigger capacitor (not shown). This causes the xenon gas between the anode 16 and trigger electrode 22 to ionise, making the gas conductive of electricity. The ionisation process then continues to the next trigger electrode 24 (and so on if there are more trigger electrodes) until the ionised, conductive gas eventually reaches the cathode 18. When that occurs a complete arc path (a breakdown path) is created. The breakdown path is thus defined in space by the physical position of the trigger electrodes 22 and 24. After the breakdown path is established, a main discharge or arc occurs between the anode 16 and cathode 18 along the breakdown path, which generates a flash.

Since the arc follows the trigger electrodes 22 and 24, the stability of positioning of these electrodes becomes critical in determining the arc position and its stability. The inventor has found that positional variations of even 0.1 mm can have readily measurable effects. Furthermore, the trigger electrodes 22 and 24 carry a substantial electric current (the trigger current), which can cause the trigger electrodes 22 and 24 to erode over time, further affecting the long-term stability of the position of the arc. To minimise these issues the trigger electrodes 22 and 24 may be made from very hard and durable metals but they also need to have sufficient thickness, for example around 0.3 mm, to prevent their becoming too flexible and eroding too quickly. A problem is that the arc formed is very narrow, having a width similar to the minimum practical thickness of a trigger electrode 22 or 24.

The xenon flash lamp 10 is pulsable, and after waiting for a hold-off time (about 1 or 2 milliseconds), the anode capacitor is recharged, and the process is then repeated. It is necessary to wait for a hold-off time after each pulse because after the main arc discharge has concluded, an ionized track remains between the anode 16 and cathode 18 inside the lamp 10. If the anode capacitor was recharged immediately, the ionized track would conduct, causing a continuous discharge inside the lamp 10, which would destroy the lamp 10. Higher flash rates are possible by use of a circuit that applies a voltage pulse to the anode 16 as well as the trigger electrodes 22 and 24, whilst simultaneously isolating the anode capacitor from the anode 16.

The research leading to this invention involved, in part, critically observing the arc properties of a Heraeus EXE2U lamp with very high resolution. The Heraeus EX2U lamp is a xenon flash lamp with two trigger electrodes. This observation showed that the incipient arc does not terminate at each trigger electrode 22 and 24 and then reform on the other side of the electrode but instead the arc is continuous and travels around the outside of each trigger electrode 22 and 24. This represents a problem, because the arc can, and does, travel around one side or the other side of each trigger electrode 22 and 24 at random from one flash to the next. The result is abrupt changes in the position of the arc from one flash to the next. A range of possible arc paths is shown in FIG. 1. The size of these changes in position is similar to the total width of the arc.

The width of an entrance aperture 12 in a spectroscopy instrument 14 may be of a similar size to the width of the arc. To make the entrance aperture 12 any wider would compromise the spectral resolution of the instrument 14. A movement in the position of the arc by as little as one arc width is enough for the projected image of the arc to miss the entrance aperture 12 almost completely, or to fill it almost completely, from one flash to the next. This may cause poor noise performance in the spectroscopy instrument 14.

The problem is further compounded by the fact that the arc travelling round one side, or the other side, of a trigger electrode 22 or 24 is a bi stable phenomenon and gives rise to a noise pattern which is not Gaussian and indeed appears quantised, making it difficult to reduce its effects by downstream data processing.

The observations of the arc referred to above also revealed that there is very little movement of the point of attachment of the arc to the anode 16 or to the cathode 18 and that consequently these regions actually show very good spatial stability (at least with reference to the anode 16 and/or cathode 18). This is entirely contrary to prior art teachings.

A further limitation observed by the inventor is that the presence of the trigger electrodes 22 and 24 locally quenches the arc emission and creates a dark region. Thus each trigger electrode 22 and 24 creates a hole in the emitting region of around 0.3 mm, which leads to a substantial reduction in collected light once the arc is imaged onto an aperture.

Another difficulty with trigger electrodes 22 and 24 is their positioning. If trigger electrodes 22 and 24 are not positioned in a straight line drawn from anode 16 to cathode 18, then the path of the arc may further deviate. This makes it difficult to image the arc onto a straight slit, and exacerbates the observed noise. The problem increases when the trigger electrode tip is reduced in diameter. Small diameter trigger electrodes 22 and 24 are often used to provide higher stability.

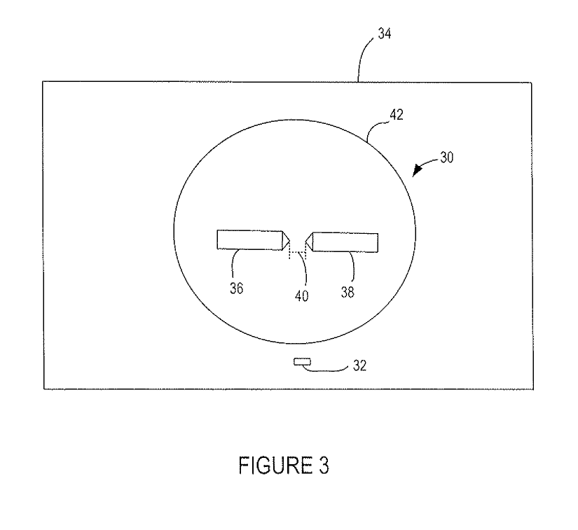

An embodiment of the present invention as depicted in FIG. 3 is a xenon flash lamp 30 without any trigger electrodes. The xenon flash lamp 30 and entrance aperture 32 form part of a spectroscopy instrument 34.

The xenon flash lamp 30 includes an anode 36 and a cathode 38 spaced apart by a distance 40. The anode 36 and cathode 38 are sealed within an envelope 42, such as a glass bulb, of pressurized xenon gas. The distance 40 between the anode 36 and cathode 38 is such that an arc can be struck between the anode 36 and cathode 38 without the use of a trigger electrode. Specifically, the distance 40 is less than 1.5 mm.

The inventor has found that with a distance 40 between the anode 36 and cathode 38 of less than 1.5 mm, trigger electrodes are not necessary to stabilise and guide the main discharge of the lamp 30. In particular, the inventor has found that a distance 40 of 1 mm gives very good results. The inventor has observed that the amount of random arc wander over the discharge path is less than the arc jump observed at trigger electrodes, and less than the total arc width.

The absence of trigger electrodes from the xenon flash lamp 30 eliminates the possibility of random arc transitions on either side of the trigger electrodes, eliminates the dark regions around the trigger electrodes and removes any errors associated with trigger electrode positioning. The present invention thus provides a pulsable light source with improved arc stability.

Similarly to the xenon flash lamp 10 described above with reference to FIGS. 1 and 2, in operation of the xenon flash lamp 30, the cathode 38 is connected to ground and an anode capacitor (not shown) is connected between the anode 36 and cathode 38. The anode capacitor is charged to a voltage of between about 200 and 1000 volts.

In this case, however, to initiate an arc, a high voltage pulse is impressed on the anode 36 via a trigger capacitor (not shown). This high voltage may be isolated from the trigger capacitor by a chain of diodes having sufficient voltage breakdown strength to withstand the trigger voltage. This causes electrical breakdown of the xenon gas from the anode 36 to the cathode 38, which is followed by a flash generated by a main discharge or arc along the breakdown path. Again, the lamp is pulsable by recharging the anode capacitor and repeating the process.

Applying a trigger pulse to the anode 36, instead of to trigger electrodes, means that there is virtually no arc wander around the anode 36. The result is that the ends of the arc, at the anode 36 and cathode 38, are the most stable while the middle of the arc, although it is the least stable, still has improved stability compared to the arc struck between the anode 16 and cathode 18 of FIGS. 1 and 2. This means that more of the arc can be imaged onto the entrance aperture 32.

Another observation made under magnification by the inventor is that an arc struck within a xenon flash lamp 10 is around 0.25 to 0.35 mm in diameter, far smaller than previously thought. This means that use of the xenon flash lamp 30 of the present invention, with a distance 40 of less than 1.5 mm produces an arc between the anode 36 and cathode 38 which has an aspect ratio (arc length to arc diameter) of 6:1 or less.

This aspect ratio may be customised to substantially match the aspect ratio of the entrance aperture 32 (aperture length to aperture width) of the spectroscopy instrument 34. This increases the amount of light from the arc that enters the aperture 32, and thus improves spectroscopic performance. The improved stability of the arc resulting from the lack of trigger electrodes further increases light throughput.

One problem of a having a shorter distance 40 is that a greater fraction of the applied voltage is lost in the electrode-to-gas transition and less along the arc length. This reduces the total light output for a given electrical input and thus means lower efficiency. The problem can be ameliorated by increasing the gas pressure in the envelope 42 of the lamp 30 to greater than 1 atmosphere. Such increase in pressure increases the arc density and thus voltage drop and light output per unit of arc length.

Increasing the pressure within the sealed envelope 42 may increase the trigger voltage requirements. However, this may to an extent be balanced by having a shorter distance 40 which decreases the trigger voltage requirements. A trigger voltage of in excess of 10 kV applied to the anode 36 may be required.

The lamp 30 may have a flash repetition rate in the range of 300 Hz to 600 Hz, for example, the repetition rate may be 500 Hz. The inventor's research recognised that high flash repetition rates allow more measurements per second, which in turn allows either more averaging to be carried out for the same overall response time, or, alternatively, faster tracking of rapidly-changing sample characteristics. Both alternatives are desirable and useful. A very fast flash rate carries a risk that the ion path from the previous flash will not have decayed sufficiently by the time the voltages are re-applied, causing the lamp to go into continuous conduction. This leads to destruction of the lamp. Indeed that has been observed on more than one occasion with a prior art lamp even with 1 ms voltage hold-off period after each flash. A benefit of using higher gas fill pressure in the lamp 30 is that the ion path decays more rapidly, which reduces this problem.

Accordingly, the inventor's research focussed on a pulse repetition rate of 500 Hz. It was found that a lamp 30 having a 1 mm arc, no trigger electrodes and a two-atmosphere xenon gas fill pressure operated entirely stably at this repetition rate and showed less flash-to-flash arc movement at 500 Hz than it did at repetition rates between 50 and 100 Hz. A hold-off time period of about 400 microseconds was enough to ensure that continuous conduction did not occur. It was also found that the acoustic noise emitted by the lamp 30 was substantially less than it was when the lamp 30 was run at the same overall power but at lower flash repetition rates. The acoustic noise generated by xenon flash lamps is very objectionable to operators and reducing this acoustic noise is of real practical advantage.

A problem when operating a lamp at these higher flash rates is the amount of energy dissipated in the trigger circuitry. When operating at higher flash rates the main storage capacitor may be reduced. The energy per flash is lower, so the total power at which the lamp is operated remains the same. Nonetheless, the energy dissipated in the trigger circuit for each flash remains the same, since it relates to what is needed to trigger the lamp. Thus a change from 50 flashes per second to 500 flashes per second increases the power dissipated in the trigger circuit by a factor of ten. This can become a significant issue. Use of a lamp without trigger electrodes reduces the required trigger energy per flash since there are fewer electrodes to drive and consequently less overall capacitance. There is consequently less of a problem with power dissipation in the drive circuit of the lamp.

It is to be understood that various alterations, additions and/or modifications may be made to the parts previously described without departing from the ambit of the present invention, and that, in the light of the above teachings, the present invention may be implemented in a variety of manners as would be understood by the skilled person.

1. A pulsable light source for a spectroscopy instrument, the light source comprising:
a xenon flash lamp having an anode and a cathode within a sealed envelope of pressurized xenon gas, a spacing between the anode and the cathode enabling an arc to be struck between the anode and the cathode without use of a trigger electrode.

2. The light source as claimed in claim 1, wherein the spacing between the anode and the cathode is such that the arc struck between the anode and the cathode has an aspect ratio (arc length to arc diameter) that substantially matches the aspect ratio of an entrance aperture (aperture length to aperture width) of the spectroscopy instrument.

3. The light source as claimed in claim 1, wherein the spacing between the anode and the cathode is less than about 1.5 mm.

4. The light source claimed in claim 3 wherein a pressure of the pressurized xenon gas within the sealed envelope is greater than 1 atmosphere.

5. The light source as claimed in claim 1, wherein the spacing between the anode and the cathode is between 0.5 mm and 1 mm, and a pressure of the pressurized xenon gas within the sealed envelope is between 2 and 4 atmospheres.

6. A spectroscopy instrument comprising:
an entrance aperture; and
a pulsable light source comprising a xenon flash lamp including an anode and a cathode within a sealed envelope of pressurized xenon gas, a spacing between the anode and the cathode being less than about 1.5 mm, enabling an arc to be struck between the anode and the cathode without use of a trigger electrode,
wherein the spacing of the anode and the cathode is selected such that the arc between the anode and the cathode has an aspect ratio (arc length to arc diameter) that substantially matches the aspect ratio of the entrance aperture of the spectroscopy instrument.

7. The spectroscopy instrument as claimed in claim 6, wherein the spacing between the anode and the cathode of the light source is less than 1.5 mm.

8. The spectroscopy instrument as claimed in claim 7, wherein a pressure of the pressurized xenon gas within the sealed envelope is greater than 1 atmosphere.

9. The spectroscopy instrument as claimed in claim 6, wherein the spacing between the anode and the cathode of the light source is between 0.5 mm and 1 mm, and a pressure of the pressurized xenon gas within the sealed envelope is between 2 and 4 atmospheres.

10. A spectroscopy instrument as claimed in claim 6, wherein the entrance aperture has an aspect ratio below 4:1 and the spacing between the anode and the cathode is between 0.5 and 1 mm.

11. A xenon flash lamp, comprising:
an anode and a cathode within a sealed envelope of pressurized xenon gas, the anode and the cathode being spaced less than about 1.5 mm apart, enabling an arc to be struck between the anode and the cathode without a trigger electrode.
